(19) United States
(12) Patent Application Publication
(10) Pub. No.: US 2025/0293760 A1
(43) Pub. Date: Sep. 18, 2025

(54) ON-BOARD METHOD AND SYSTEM FOR SELECTING A COMMUNICATION CHANNEL BETWEEN AN AIRCRAFT AND A REMOTE STATION

(71) Applicant: Airbus Operations (S.A.S.), Toulouse (FR)

(72) Inventors: Luc Emberger, Toulouse (FR); Flora Jamgotchian, Toulouse (FR); Stéphane Pintiaux, Toulouse (FR)

(21) Appl. No.: 19/073,672

(22) Filed: Mar. 7, 2025

(30) Foreign Application Priority Data
Mar. 15, 2024 (FR) FR2402611

(51) Int. Cl. H04B 7/185

(52) U.S. Cl. CPC H04B 7/18502

(57) ABSTRACT

A method for selecting a communication channel, called utilization channel, includes a step of determining, for each channel, one or more items of information representing a transmission quality of a message, with the message being either a “useful” message received by the on-board system, or a probe message, called “ping” message, a step of classifying the communication channels according to indices respectively representing transmission qualities, based on the information, a step of selecting the utilization channel as being the channel exhibiting the best transmission quality based on the indices, a step of determining a buffering time for each received useful message, and, if this time is non-zero, a step of transmitting the useful message, called eligible useful message, instead of a ping message.

### TECHNICAL FIELD

The disclosure herein relates to an on-board method and system for selecting a communication channel, from among a plurality of communication channels, between an on-board communication system of an aircraft and a communication station remote from the aircraft, for example, disposed on the ground.

### BACKGROUND

Aircraft most often use a system for communicating data to one or more ground stations, allowing operators to establish radio monitoring of the aircraft, by obtaining various items of operational and logistical information in a detailed manner, such as, for example, the location of the aircraft, but also its status, and information relating to any faults. This allows maintenance actions to be organized in advance, and to be carried out after the aircraft returns to the ground. A well-known system of this type is conventionally called ACARS, “Aircraft Communication Addressing and Reporting System”. This system relies on communications that are initially based on HF and VHF transmission channels and more recently on SATCOM-type satellite links, in particular in oceanic zones.

In many flight situations, several communication channels are available at the same time, and the transmission quality over these channels can vary differently depending on the type of channel. In some uses, a list defining channel usage preferences is statically defined in an on-board database of the relevant aircraft. Furthermore, it is sometimes possible to select one channel over another based on the operating cost.

However, such practices can result in using a transmission channel that is not the most efficient at a given instant. In addition, depending on the method for monitoring and managing transmission quality, successive switching of transmission channels can prove to be counterproductive and a good balance must be found between the advantage that a change of channel can provide and the risks inherent in switching too frequently.

It is then possible to use a method for selecting a channel, called utilization channel, from among the plurality of communication channels between the aircraft and the remote station, as known from document FR 2202302, which associates a transmission quality index with each channel and allows the best communication channel to be selected in real time. This method ensures increased reliability of data transmissions between the aircraft and the remote station by optimizing the selection of a transmission channel and the conditions for switching from one channel to another in order to minimize any risks of interruption to the service.

To this end, this method of the prior art anticipates analyzing the transmission of two types of messages. The first type of messages includes messages, called useful messages, which are messages containing information that must be sent by the aircraft to the remote station. The second type of messages includes ping messages, which are sent regularly and are intended to be analyzed in order to determine a transmission quality index. These ping messages ensure that the selection method functions properly, even when no useful messages are being sent.

Nevertheless, this method involves regularly sending ping messages in addition to the useful messages. It would be beneficial to limit the resulting increase in information traffic.

The aim of the disclosure herein is to at least partly overcome these disadvantages.

### SUMMARY

To this end, a method is proposed for selecting a communication channel, called utilization channel, from among a plurality of communication channels between an on-board communication system of an aircraft and a communication station, called remote station, disposed at a distance from the aircraft, the method comprising:
a step of determining, for each of the communication channels, one or more items of information representing the transmission quality of a message between the on-board system and the remote station, the message being either a “useful” message received by the on-board system, or a probe message, called “ping” message, with the ping messages being transmitted over a given period;
a step of classifying the communication channels according to indices respectively representing the transmission qualities determined for each of the channels, based on the determined information, with a single index being assigned for each channel;
a step of selecting the utilization channel as being the channel, from among the communication channels, exhibiting the best transmission quality based on the indices;
   the method also comprising:
a step of determining a buffering time, called eligibility time, for each received useful message; and, if the eligibility time is non-zero,
a step of transmitting the useful message, called eligible useful message, instead of a ping message via the utilization channel.

Thus, by virtue of the method according to the disclosure herein, ping message traffic is reduced, which limits the mobilization of the communication system and ensures good quality for the communication network, while reducing the costs generated by selecting a better channel.

It should be noted that a “useful” message received by the on-board system is understood to mean a message transmitted to the on-board system by a source transmitting application that itself is on board the aircraft, i.e., a message entrusted by the source transmitting application to the on-board system in order to be sent to the remote station, which should not be confused with a message received from the ground station.

According to another aspect, the method comprises a step of analyzing the buffering of the eligible useful message, comprising a checking step depending on a state of the buffer memory and a parameter relating to the eligible useful message.

According to another aspect, the on-board system comprises at least one buffer memory, wherein the step of analyzing the buffering of the eligible useful message comprises a step of determining an order for filling the at least one buffer memory.

According to another aspect, the on-board system comprises a respective buffer memory for each channel, wherein the step of analyzing buffering comprises a step of determining an order for filling the buffer memories.

According to another aspect, the step of determining a filling order comprises a step of computing a duration between the transmission of at least the next ping message over each channel and a time for the on-board system to receive the eligible useful message, and a classification of the obtained durations in ascending order, with the buffer memory filling order following the obtained classification.

“Reception time” is understood to mean the maximum time for storing the eligible useful message.

According to another aspect, during the step of comparing between a state of the buffer memory and a parameter of the eligible useful message, for the channel whose buffer memory is to be filled as a priority according to the order obtained on completion of the step of determining a filling order, if the buffer memory is empty, and if a maximum message buffering time is greater than the duration remaining until the next transmission of a ping message, then the eligible useful message is placed in the buffer memory during the step of analyzing buffering.

According to another aspect, if the maximum message buffering time is less than or equal to the duration remaining until the next transmission of a ping message, then the eligible useful message is not placed in the buffer memory and is sent as a useful message during a sending step.

According to another aspect, with the on-board system comprising a buffer memory common to all the channels, during the step of comparing between a state of the buffer memory and a parameter of the eligible useful message, a number of messages, called number of messages, contained in the buffer memory is compared with a total number of ping messages, called number of pings, to be sent over a time equal to a maximum message buffering time and, if the number of pings is greater than the number of messages, then the eligible useful message is placed in the buffer memory, during the step of analyzing buffering.

According to another aspect, if the number of pings is less than or equal to the number of messages, then the eligible useful message is not placed in the buffer memory and is sent as a useful message during a sending step.

A further aim of the disclosure herein is an on-board communication system intended to equip an aircraft, configured to establish communications with a remote communication station through a communication channel, called “best channel”, from among a plurality of communication channels, with the on-board system comprising electronic and electromagnetic circuits configured to implement the following steps:
a step of determining, for each of the communication channels, one or more items of information representing the transmission quality of a message between the aircraft and the remote station, the message being either a “useful” message received by the on-board system, or a probe message, called “ping” message, with the ping messages being transmitted over a given period;
a step of classifying the communication channels according to indices respectively representing end-to-end transmission qualities determined for each of the channels, based on the determined information, with a single index being assigned for each channel;
a step of selecting the utilization channel as being the channel, from among the communication channels, exhibiting the best transmission quality based on the indices;
a step of determining a buffering time, called eligibility time, for each received useful message, and, if the eligibility time is non-zero, a step of transmitting the useful message, called eligible useful message, instead of a ping message.

More generally, the on-board system is configured to implement the selection method as described above.

A further aim of the disclosure herein is an aircraft comprising an on-board communication system.

A further aim of the disclosure herein is a computer-readable medium comprising instructions for executing the method as described above.

### BRIEF DESCRIPTION OF THE DRAWINGS

Further features, details and advantages will become apparent upon reading the following detailed description and by analyzing the appended drawings, in which:

FIG. 1 is a schematic representation of a communication system for transmitting data between an aircraft operating on the ground or in flight and a communication station remote from the aircraft;

FIG. 2 is a flowchart illustrating the overall sequence of the method for evaluating the performance of each of the available communication channels between the aircraft and the remote station 3 of FIG. 1;

FIG. 3 illustrates the steps of selecting a communication channel referred to as being the best available communication channel between the aircraft 2 and the remote station 3, from among channels C1, C2 and C3;

FIG. 4 illustrates a flowchart of the selection method according to the disclosure herein;

FIG. 5 illustrates an example of the method of FIG. 4 according to a first embodiment;

FIG. 6 illustrates an example of the method of FIG. 4 according to a second embodiment;

FIG. 7 illustrates an example of the internal architecture of an on-board system according to the disclosure herein.

### DETAILED DESCRIPTION

The examples and associated conditions described herein are mainly intended to help the reader to understand the principles of the disclosure herein and not to limit its scope to these specific examples and conditions. It will be understood that a person skilled in the art can conceive of various arrangements which, although not explicitly described or represented herein, nevertheless embody the principles of the disclosure herein and are included within its spirit and scope.

Furthermore, for ease of understanding, the following description may describe relatively simplified implementations of the disclosure herein. As understood by a person skilled in the art, other implementations of the disclosure herein may be more complex.

In some cases, examples of modifications of the disclosure herein also may be presented. This is simply to assist understanding, and, again, not to define the scope or to establish the limits of the disclosure herein. These modifications are not an exhaustive list, and a person skilled in the art will be able to make other modifications, while remaining within the scope of the disclosure herein.

Furthermore, all the following statements concerning the principles, aspects and implementations of the disclosure herein, as well as the specific examples thereof, are intended to encompass both the structural and functional equivalents thereof, whether they are currently known or are developed in the future. Thus, for example, a person skilled in the art will understand that all the functional diagrams represent conceptual views of examples of circuits incorporating the principles of the disclosure herein. Similarly, it will be clearly understood that all the flowcharts, status transition diagrams, pseudo-codes, and the like, represent various methods that can be implemented on computer-readable media, and thus can be executed by a computer or a processor, whether or not such a computer or processor is shown in the figures.

The functions of the various elements shown in the figures, including any functional blocks, can be provided by using dedicated hardware, as well as by hardware capable of executing appropriate software. They also can be executed by a processor. Other conventional and/or custom hardware also can be used.

The software modules, or the modules that are supposed to be software, can be represented herein as a combination of flowchart elements, or of other elements indicating the execution of the steps of a process, and/or as a textual description. Such modules can be executed by hardware that may or may not be expressly represented. Furthermore, it must be understood that “module” can include, for example, but not be limited to, computer program logic, computer program instructions, software, a software stack, firmware, a hardware circuit, or a combination of these various elements that provides the required capabilities.

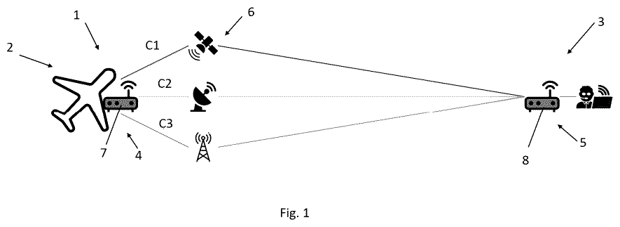

As can be seen from the figures, the disclosure herein relates to a method 100 for determining a communication channel, called utilization channel, also called best channel, from among a plurality of communication channels between a communication system 1 of an aircraft 2 and a communication station located at a distance from the aircraft, and referenced 3 in FIG. 1, and hereafter called remote station 3. A further aim of the disclosure herein is the communication system 1 for implementing the method 100.

In the following description, it is assumed, without limitation, that the system 1 comprises three communication channels C1, C2 and C3.

The communication system 1 comprises an on-board communication system 4 equipping the aircraft 2 and a system 5, called ground system, disposed at a distance from the on-board system 4, equipping the remote station 3. The system 1 also comprises a transmission device 6 for channels C1 to C3 for transmitting information between the aircraft 2 and the remote station 3.

Preferably, the on-board system 4 comprises a router 7. The system 4 also comprises an on-board application that is configured to ensure any downlink of information traffic to the ground and optionally to receive information from the on-board system 5.

Preferably, the ground system 5 comprises a router 9. The system 5 also comprises an application for receiving the information traffic originating from the on-board system 4, and, optionally, for sending an uplink to the on-board system 4.

The transmission device 6 comprises communications that are initially based on HF and/or VHF and/or SATCOM type transmission channels, and/or any other communications used in aeronautics, such as L-DACS, for example, or such as a “virtual” communication channel seen from a router, such as a local link, notably of the Ethernet type, to a cabin system that agnostically provides a plurality of physical links.

Advantageously, and by virtue of the communication system 1, the aircraft 2 can transmit a wide variety of data to the remote station 3, notably in order to accurately locate the aircraft, but also to organize management, operation and maintenance actions, during the flight or after returning to the ground. Furthermore, the communication system of the aircraft allows relevant information to be provided that is useful for the operation of the aircraft, such as, for example, meteorological information or information related to a flight plan of the aircraft or of a third-party aircraft.

The on-board system 4 is configured to execute the method 100.

As known from document FR 2202302, the “best channel” is selected based on at least one primary communication performance criterion and optionally other secondary communication criteria. The term “performance criterion” used herein refers to a criterion for assessing the end-to-end (between the aircraft and a remote communications station) transmission quality, or the quality of the transmission link.

Preferably, the primary communication performance criterion is the latency of the considered channel and the secondary criteria, which are optionally considered, are communication performance quality criteria such as, by way of an example, a signal-to-noise ratio or information representing the use made of the channel (rate of use, duration of continuous use, error rate, etc.).

According to variants, the primary performance criterion for assessing end-to-end transmission quality is a criterion other than latency, representing transmission quality via a communication channel, such as, by way of examples, a signal-to-noise ratio or information representing the use made of the channel (rate of use, duration of continuous use, error rate, etc.), optionally weighted by one or more secondary criteria.

The latency of a channel is defined herein as the total travel time of data sent from the aircraft 2 to the remote station 3 and then sent back from the remote station 3 to the aircraft 2. The latency thus defined can be expressed as the addition of a “downlink” latency (from the aircraft 2 to the station 3) and an “uplink” latency (from the station 3 to the aircraft 2), with the local processing times of the remote station 3 preferably being disregarded.

According to one embodiment, the latency of a channel is determined by an index representing a determined latency value or a set of successively determined latency values. The determined latency values mainly form the information used to determine a single latency index for each channel. In other words, a latency index specific to a given channel can be determined from a determined latency value or from a set of determined latency values for this channel over a given time interval, such as, by way of examples, a minimum latency, a maximum latency or even an average or median latency. When latency indices are determined for each of the communication channels, the communication channels are classified by index. Thus, the lowest latency index corresponds to the latency index of the communication channel detected as offering the best communication performance from among the available channels, and the highest latency index corresponds to the latency index of the communication channel detected as offering the worst communication performance, or vice versa. According to one embodiment, information representing the latency of a channel at a given instant is determined from transmissions that have just been established by determining the end-to-end travel time of a data packet.

According to another embodiment, information representing the latency of a channel at a given instant is determined by using a “ping” function, commonly used in communication networks, notably computer networks, and based, for example, on communication protocols such as TCP (Transmission Control Protocol) or ICMP (Internet Control Message Protocol). In general, the ping function is a computer command intended to test the accessibility of a remote machine through a communication network and to measure, in the event that the remote machine is accessible, the time taken to receive a response, also called “Round-Trip Time” (RTT).

According to another embodiment, the latency of a communication channel is determined based on “useful” communications established via this channel, and in the absence of sufficiently regular communications, the ping function is used in addition to the “useful” communications. In the case of latency defined based on “useful” communications established over a communication channel, the one or more data packets used to determine latency includes information similar to that used in the messages implementing a ping function.

The distribution between the transmission of useful and ping messages is described hereafter in relation to the description of the method 100.

After characterizing the latencies of the various communication channels available between the aircraft 2 and the remote station 3, and consequently, the performance capabilities of these various channels, namely channels C1, C2 and C3, the on-board system 4 can check whether the channel offering the best communication performance is still the channel used initially (i.e., at the beginning of the activation of the method 100, which, for the sake of simplicity, is assumed to be the first channel C1), and, if applicable, can change the utilization channel. Thus, if the on-board system 4 detects that the channel determined to be the best channel is not the one over (via) which the first communications are established, the system begins to establish second communications, via a second communication channel, which is the best detected communication channel, at the same time as the first communications established over the first channel. In this configuration, the transmissions established between the aircraft 2 and the remote station 3 are redundant and the remote ground station manages the redundancy of the data it receives by eliminating duplicates.

The on-board system 4 scans the evolution of the classification that it assigns to the channels, in terms of performance, for a predetermined period DP, so that, if at the end of the period DP, the second channel is still the best channel, then the first communications established via the first channel are interrupted. In this case, the second communication channel, which is now the only communication channel, “becomes” the first channel and the second communications “become” the first communications and the method for determining the best channel continues to run on this new basis. Otherwise, the on-board communication system 4 continues to establish the first communications via the first communication channel. According to one variant, in order for the on-board communication system 4 to stop establishing the first communications and to switch the channel between the first communication channel and the second communication channel (determined to be the best communication channel), the second channel not only needs to be the best channel at the end of the delay DP, but also for it to have remained so throughout the delay DP, which tends to show and mean that it is possible to check that the second communication channel is reliable enough at this instant, or at the very least that it offers performance capabilities in line with expectations at this instant. This also allows a temporal filter to be created that avoids switching channels when the relative situation of the various channels is not at all stable in terms of performance capabilities (transient phenomena).

According to one embodiment, the on-board system 4 of the aircraft 2 transmits the classification of the channels by performance index to the remote station 3, so that the remote station 3 is notified of the relative quality of the communication channels as assessed by the aircraft 2. This information can be sent to the remote station 3 in the form of data coded and identified according to a predefined protocol. For example, a packet header has a recognizable identifier and comprises a number of channels, followed by a list of channel identifiers, classified in ascending or descending order of performance. Thus, the remote station 3 can select a communication channel for establishing uplink communications, in the event that the communications are not established via the same communication channel as that used to establish downlink communications. According to one embodiment of the disclosure herein, the remote station 3 establishes any uplink communication on the last channel used for a downlink communication. According to a variant, the remote station 3 uses the channel performance related information received from the aircraft to select the channel to be used for subsequent uplink communications.

Advantageously, various channel latency evaluation techniques can be implemented to evaluate latency according to the type of channel that is used. For example, the latency evaluation of a first channel can be carried out using a ping network command (or function) according to an ICMP protocol, and the latency evaluation of a second communication channel can be carried out using a ping network command according to a TCP protocol. According to a similar line of reasoning, the latencies of only the downlinks are used to classify channels in terms of performance capabilities.

According to one example, the latency of a communication channel can be determined by deducting the transmission time of a message from an on-board system 4 from the reception time for this same message by the remote station 3, in terms of downlink latency. According to another example, the latency of a channel can be determined by deducting the reception time of an acknowledgement of receipt, sent by the remote station 3 in response to a message sent by the aircraft, from the transmission time of this message by the on-board system 4 of the aircraft. Furthermore, an approximation can be made to determine the latency of an uplink or downlink as being half the round-trip time (RTT).

In the event that a ping function is used to determine latency, the ping network commands or functions include information that is useful for the proper execution thereof, namely, a ping command identifier, a transmitter identifier, a recipient identifier, a transmission instant, a reception instant by the recipient, a link type, one or more message (command) routing device identifiers, a quality index determined by the aircraft for the channel used, etc. This list of examples is not exhaustive.

Advantageously, the evaluation of a channel carried out by the on-board system 4 can include other parameters, such as, by way of an example, a link quality index (signal-to-noise ratio, for example), a transmission error rate via the relevant link, “jitter”, which is defined as the variation in the latency over time, a number of latency measurements taken over a predetermined time interval, so as to indicate a reliability rate of the determined latency, a communication channel occupancy rate. For example, the latency indices determined for each channel can be weighted by a weighting coefficient that is defined, for each channel, by a transmission quality index and/or by an index representing a use of the considered channel over a predefined time interval.

According to one embodiment, at the same time the on-board system 4 executes a first method for evaluating the performance of each channel and for classifying the channels according to an index, which is mainly determined, for each channel, from the latency of this channel, and a second method for selecting a best communication channel from the classification carried out in the background. The two methods are in fact two sub-methods of the overall method for selecting a communication channel according to the disclosure herein.

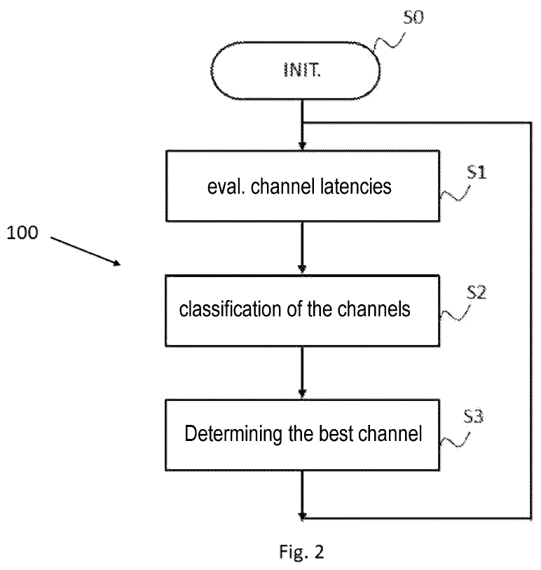

FIG. 2 is a flowchart illustrating the overall sequence of the method (or, more specifically, sub-method) for evaluating the performance of each communication channel available between the aircraft 2 and the remote station 3, for defining a single index per channel determined from the latency of the channel, optionally weighted by another transmission performance index, then for classifying the communication channels according to the determined indices, so as to define an established order, starting from the best communication channel to the worst communication channel, or vice versa.

As can be seen in FIG. 2, a step S0 is a step of initializing the aircraft systems 2, at the end of which the aircraft systems are supplied with electrical energy, initialized and normally operational. In particular, the on-board system 4 is configured to be able to establish the first communications over a first available and selected communication channel, in particular to the remote station 3.

During a step S1, ping commands are executed at regular intervals over all the communication channels available between the aircraft 2 and the remote station 3, so as to define one or more items of latency information for each channel.

The ping command execution frequency is, according to one example, such that a ping command is sent once every x seconds, where x ranges, for example, between 1 second and 60 seconds, for example, 2 seconds, 6 seconds, 8 seconds, 10 seconds, 30 seconds. However, this frequency for measuring the latency of a communication channel can be increased or decreased according to the results observed on each communication channel. Furthermore, this evaluation frequency per channel can differ from one channel to another, depending on the type of channel, in particular.

According to the method 100, as will be described hereafter, “useful” communications can be sent instead of ping messages, or even can be frequent enough to avoid the use of ping commands, and the current communications are used to define the latency of each of the available communication channels. The data packets exchanged over the channel then contain all the useful information needed to determine latency, i.e., information equivalent to that present in a ping command for computing latency. A range of latency values and an average latency value can be defined for each communication channel C1, C2, C3 and a latency index can be determined from this latency information. A latency index can be determined, for example, so that the channel with the highest latency is assigned a latency index of 10 and the channel with the lowest latency is assigned a latency index of 0, or vice versa, depending on the index definition convention used. Typically, in the on-board communication system 4, the latency values are expressed in seconds. The latency of each channel is thus evaluated for a duration T1, usually several minutes.

During a step S2, the latency indices defined for each channel are recorded in a table and the channels are classified in this table in order of performance (latencies or weighted latencies). The channel classification table is stored, for example, in a volatile or non-volatile memory of the on-board communication system 4 of the aircraft 1. A step S3 involves identifying the communication channel whose index represents the best communication performance, so that the improved method for selecting a communication channel, executed by the on-board system 4, can, by sampling reading a memory, identify the channel exhibiting the best communication conditions to the remote station 10.

After step S3, the method loops back to step S1, which means that the evaluation of channel latency is carried out continuously, in the background, by the on-board system 4 of the aircraft 2. In the event that secondary information, representing the transmission quality of the channels, is used to weight the latency indices of the channels, these operations are executed during step S1 and the weighted indices are considered for the classification carried out in step S2. In this case, the information representing the quality of the transmissions is defined as protocol and is transmitted during exchanges of messages between the aircraft 2 and the remote station 3, but also, optionally from third-party communications, to reference equipment.

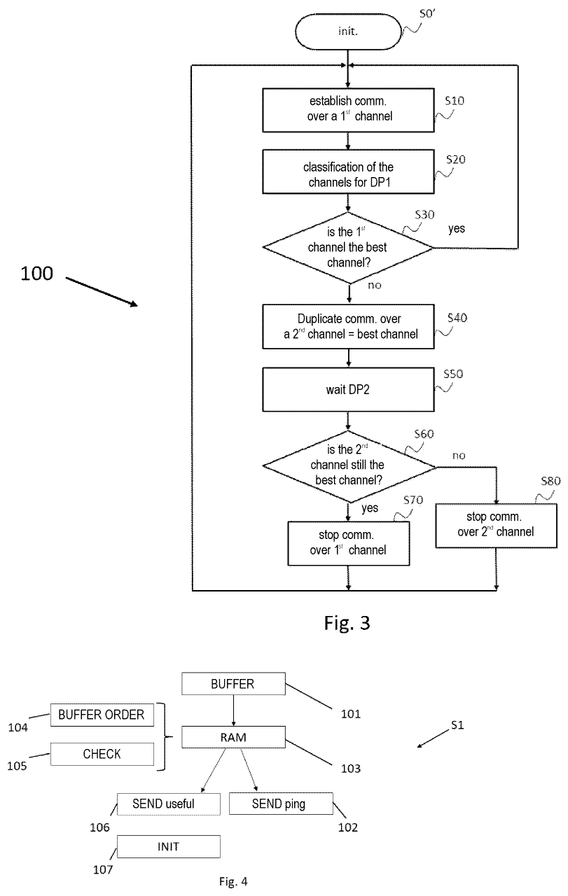

FIG. 3 illustrates the steps of selecting a communication channel referenced as being the best communication channel available between the aircraft 2 and the remote station 3, from among channels C1, C2 and C3. Here again, more precisely, it is a sub-method of the improved method for selecting a communication channel according to the disclosure herein, since according to the described embodiment, two sub-methods executed at the same time carry out the steps of the complete method. A step S0′ corresponds to a step of initializing the systems of the aircraft 2, at the end of which the systems are supplied with energy, initialized and normally operational. In particular, the on-board system 4 is configured to be able to establish the first communications over a first available and selected communication channel, in particular to the remote station 3. According to one embodiment, the steps S0 and S0′ are combined into a single step, called “start-up” step, of the aircraft. During a step S10, the on-board communication system 4 of the aircraft 2 sends initial information (data) to the remote station 3, after having selected a first communication channel to the remote station 10, then waits, during a step S20, for a duration DP1 (typically from several seconds to several minutes), until the best channel can be determined in the background, so as to be able to determine, at the end of a step S30, whether or not the first channel selected to establish the first communications is the best channel. If, in step S30, the channel currently in use (that is, the first channel) is determined as being the best channel, the method loops back to step S10 and therefore continues to establish communications with the remote station via the first channel. Otherwise, i.e., if the current channel is not the best channel, the method initiates, during a step S40, additional communications, in this case again called second communications, via a second communication channel, which is none other than the channel determined as being the best channel by reading the information contained in the memory of the on-board system 4, and updated by the continuous execution of the method 100. A new waiting phase, for a duration DP2, is then carried out during a step S50, with the aim of creating a “time filter”, i.e., with the aim of being able to check whether the second channel continues to offer the best communication performance capabilities at the end of the delay DP2. To this end, a new phase of reading the best communication channel is carried out during a step S60, at the end of the delay DP2. According to one embodiment of the disclosure herein, the duration DP2 ranges, for example, between 1 minute and 4 minutes, for example, 2 minutes.

In the event that the second channel is still the best channel at the end of the delay DP2, the first communications established over the first channel are stopped during a step S70 and the method loops back to step S10. In this case, the second channel is then considered to be the first channel for the reiteration of the described sub-method and the second communications are then considered to be the first communications. Otherwise, i.e., if another channel is determined as being the best communication channel at the end of the delay DP2 during step S60, the second communications established over the second channel are stopped during a step S80 and the first communications continue to be established over the first channel, then the method loops back to step S10. Advantageously, and according to one embodiment of the disclosure herein, steps S50 and S60 involve checking that the second communication channel remains the best communication channel throughout the entire duration of the delay DP2. Otherwise, additional information is defined (an indicator of the variation of the best channel during the delay DP2) allowing the result of the test carried out during step S60 to be forced.

According to one embodiment of the disclosure herein, the described selection method can be deactivated by an operator in the aircraft or on the ground in order to then select a communication channel from a second selection method, using, for example, statically defined communication channel preference criteria.

Reference will now be made to FIG. 4.

As can be seen from this figure, the method 100 also comprises, during step S1:
a step (101—TAMP) of determining a time, Tbx, called eligibility time, for buffering each received useful message Mx; and, if the eligibility time is non-zero,
a step (102—ENV ping) of transmitting the useful message as a ping message, i.e., instead of a ping message.

The buffering time Tbx can be, for example, the maximum possible buffering time, taking into account a delay that is considered to be acceptable for the message and, optionally, the transmission delay of the communication network. More generally, the buffering time can be any time characteristic of an acceptable buffering time.

“Non-eligible messages” are useful messages with a buffering time of zero. “Eligible messages” are useful messages with a non-zero buffering time. For these messages, the method 100 comprises, preferably in step S1, a step (103—RAM) of analyzing the buffering of the useful message, with the message having been transmitted during step 102 at an appropriate time instead of a ping message, as will be described hereafter.

Thus, by virtue of the buffering of the useful messages, as soon as possible, to be sent instead of ping messages, the method 100 reduces the number of messages exchanged between the aircraft 2 and the remote station 3, which preserves the communication network 1, reduces the energy required to operate the system 1 and reduces the associated cost.

By way of a reminder, for each channel C1, C2, C3, pings are sent by the system 4 at a set frequency. Tp1 denotes the transmission period of pings P1 over channel C1, Tp2 denotes the transmission period of pings P2 over channel C2 and Tp3 denotes the transmission period of pings P3 over channel C3.

As also can be seen from FIG. 4, since the system 4 comprises at least one buffer memory, the step 103 of analyzing the buffering of the eligible useful message comprises a step (104—ORD TAMP) of determining an order for filling the at least one buffer memory, which step is described hereafter for each of the two described embodiments.

As also can be seen from FIG. 4, the step 103 of analyzing the buffering of the eligible useful message comprises a checking step (105—VER) depending on a status of the buffer memory and a parameter relating to the eligible useful message, which step is described hereafter for each of the two described embodiments.

The first embodiment will now be described.

According to a first embodiment, each channel C1, C2, C3 has a respective buffer memory, denoted B1, B2, B3. According to this non-limiting embodiment, the buffer memories B1 to B3 have space for one message only.

According to this embodiment, illustrated in FIGS. 4 and 5, step 103 comprises a preliminary step (104—ORD TAMP) of determining an order for filling the memories B1, B2, B3. The memories B1, B2, B3 are filled according to an order that follows a rule, called next ping rule, which will be explained hereafter.

During step 104, the method 100 computes, for each channel and at a given time T0 for receiving a message, the duration remaining until the transmission of the following one or more pings.

It should be noted that, in the present description, “reception of useful message” or “received useful message” corresponds to a message initiated by the on-board source application of the message and received (or transmitted) by the (or to the) on-board communication system responsible for managing communication with the ground.

In other words, the time difference between each of the times Tp1, Tp2, Tp3 and T0 is determined, and, if applicable, the time difference between multiples of the periods Tp1 (Tp1′, Tp1″) to Tp3 and T0, and each difference D is classified in ascending order.

The order for filling buffer memories B1, B2, B3 is deduced therefrom: the memory filled as a priority, or priority memory, is the memory for which the channel exhibits the smallest time difference, Tmin, the second priority memory is the memory, from among the memories other than the priority memory, for which the channel exhibits a smaller time difference (after Tmin), and so on until all the memories have been evaluated.

Each time an eligible useful message Mx is received by the on-board system 4, the method 100 comprises a step (105—VER) of checking the filling status of the priority buffer memory Bi.

If it is not empty, the filling status of the second priority buffer memory is checked.

If it is empty, the method 100 comprises a step of comparing between the time, D, that remains until the next transmission of a ping message over the channel Ci of the buffer memory Bi and the maximum message buffering time, Tbx. If the time Tbx is greater than the time D, then the message Mx is placed in the buffer memory Bi, during step 103. Otherwise, the message Mx can no longer be delayed and is sent as a useful message, during a sending step (106—ENV ut).

Then, the method 100 comprises a step (107—INIT) of reinitializing the sequence of ping messages.

Particular reference is made to FIG. 5, which illustrates an example of the embodiment, which of course is not limiting, of the first embodiment of the method 100.

As can be seen from this figure, three communication channels are considered, C1, C2 and C3. Each channel has a “ping” period of 2 s (for C1), 4 s (for C2) and 8 s (for C3), respectively.

Three successive messages will be considered, denoted Ma, Mb and Mc. Each of the messages Ma, Mb and Mc has a maximum buffering time, denoted Tba, Tbb and Tbc, respectively, such that Tba=8 s, Tbb=10 s and Tbc=1 s.

The message Ma is received by the on-board system 4 at T0. The message Mb is received by the system 4 at T0+0.5 s. The message Mc is received by the on-board system 4 at T0+3.5 s.

In FIG. 5, Tp1 denotes the transmission time of the first “ping” P1 over channel C1 immediately after T0, Tp1′ denotes the transmission time of the “ping” P′1 after the “ping” P1 over channel C1, Tp2 denotes the transmission time of the first “ping” P2 over channel C2 immediately after T0, and Tp3 denotes the transmission time of the first “ping” P3 over channel C3 immediately after T0.

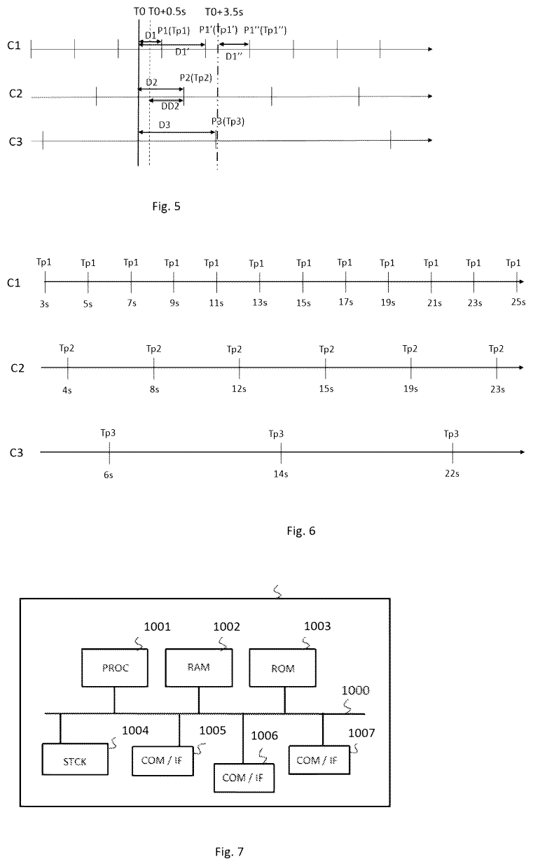

In FIGS. 6, T0=Tp1−1 s=Tp2−2 s=Tp3−3.5 s has been selected.

In the example in FIG. 6, four “pings” are considered.

During step 104, the order of priority for filling the buffer memories is defined according to the next “ping” to occur. As already indicated, during step 101, each of the following differences is computed: D1=Tp1−T0=1 s; D2=Tp2−T0=2 s; D3=Tp3−T0=3.5 s; D1′=Tp1′−T0=3 s.

In the case in point, D1<D2<D1′<D3. Thus, the “pings” will be successively P1, P2, P1′ and P3. This yields the following order for filling the memories: B1, then B2 and B3.

Step 105 involves determining whether the message Ma can be buffered, and if so, on which channel.

In this case, according to the established order for filling the memories, this involves knowing if the message Ma can be buffered in the memory B1. Two conditions must be met, namely:
B1 empty, which is the case; and
the maximum buffering time is greater than the ping time P1.

By comparing D1 and Tba, it can be seen that D1=1 s<Tba=8 s. Thus, the message Ma is effectively buffered in the memory B1.

The message Mb is received by the system 4 at the time T0+0.5 S.

Since the memory B1 is full, the message Mb can be buffered in the memory B2 if B2 is empty and its maximum time Tbb is greater than the ping time P2, which is the case, since DD2=Tp2−(T0+0.5)=1.5 s<Tbb=10 s.

The message Mb is thus buffered in the memory B2.

At the time T0+1 s, the message Ma is sent instead of the “ping” P1 over channel C1 to the remote station 3.

At the time T0+2 s, the message Mb is sent instead of the “ping” P2 over channel C2 to the remote station 3.

At the time T0+3 s, it is once again the turn of the first channel C1 to transmit a “ping”. Since the memory B1 is empty, no message can be sent as a “ping” and a “ping” is then sent over the channel C1.

At the time T0+3.5 s, the message Mc is received by the system 4.

At the time T0+3.5 s, the filling order is B1-B2-B3, according to a computation identical to that already described.

In order for the message Mc to be buffered in the memory B1, two criteria must be met:
B1 is empty;
the maximum buffering time (Tbc) is greater than the time difference D1″ between the time of the next ping P1″ on channel C1 and the current instant (in this case T0+3.5 s), D1″=1.5 s. However, this time D1″ is greater than the maximum buffering time Tbc of the message Mc.

The message Mc cannot be buffered and is sent directly over the utilization channel. The channel quality index is then evaluated by virtue of sending this message, in accordance with the teaching of patent FR 2202302. If the utilization channel is the second channel C2, then the message Mc is sent over the second channel C2 to the remote station 3.

Then, the chronology of the “ping” periods of channel C2 is reset to the sending time of the message Mc, in step 107. Upon receipt of the next useful message, the method 100 can again establish the order for filling the memories B1, B2, B3 according to step 104.

According to a second embodiment, the buffer memory B is common to the three channels C1, C2, C3. It should be noted that, according to this embodiment, the method 100 maintains the chronological order of the pings at all times. It also should be noted that, according to this embodiment, the buffer memory has a variable size.

According to this embodiment, illustrated in FIGS. 4 and 6, the method 100 comprises a step (105—VER) of comparing a state of the buffer memory B with a parameter relating to the eligible useful message. The status of the buffer memory B corresponds to the number of useful messages contained in the buffer memory B, Nm. The parameter relating to the eligible useful message is the number of pings to be transmitted over the three channels C1, C2, C3 during the maximum buffering time Tb, Np.

If the number of pings Np is greater than the number of messages Nm, then the eligible useful message is placed in the buffer memory during step 103 of analyzing buffering.

If the number of pings Np is less than or equal to the number of messages Nm, then the eligible useful message is not placed in the buffer memory and is sent as a useful message during a sending step (106—ENV ut).

As shown in FIG. 4, the method 100 also comprises a step 104 of ordering the sending of the messages contained in the buffer memory B. The messages contained in the buffer memory are classified according to a parameter that is a time difference between the maximum buffering time of the memory and the time where the method 100 is located (which is a time for the on-board system 4 to receive a message). The time differences are classified in ascending order. It is this order that determines the running order of the messages, from the highest priority message (corresponding to the smallest time difference) to the lowest priority message (corresponding to the largest time difference).

An example illustrating this second embodiment will now be described with reference to FIG. 6. In this example, the ping periods over channels C1, C2 and C3 are respectively: Tp1=2 s, Tp2=4 s, Tp3=8 s.

As already indicated, the method 100 maintains the chronological order of the pings at all times. In the example, the sequence is as follows: Tp1, Tp2, Tp1, Tp3, Tp1, Tp2, etc., as shown in FIG. 6 and as summarized in the following table:

| Next | | |
|---|---|---|
| ping | Time | |
| Tp1 | 3 | s |
| Tp2 | 4 | s |
| Tp1 | 5 | s |
| Tp3 | 6 | s |
| Tp1 | 7 | s |
| Tp2 | 8 | s |
| Tp1 | 9 | s |
| Tp1 | 11 | s |
| Tp2 | 12 | s |
| Tp1 | 13 | s |
| Tp3 | 14 | s |

Three messages will be considered, a first message Ma received by the on-board system 4 at T0, with a maximum buffering time Tba=8 s, a second message Mb received at T0+2 s with a maximum buffering time Tbb=10 s, and a third message Mc with a maximum buffering time Tbc=5 s is received by the on-board system 4 at T0+3.5 s.

At the instant T0, the message Ma is received by the on-board system 4.

The message Ma is placed in the buffer memory if the number of useful messages in the buffer memory is less than the number of pings to be performed in the time interval Tba. In this case, the buffer memory is empty, therefore, the message Ma is placed in the buffer memory, with its initial time Tba, equal to 8 s.

At the time T0+2 s, the message Mb is received by the on-board system 4.

The message Mb is placed in the buffer memory if the number of useful messages in the buffer memory is less than the number of pings to be performed in the time interval Tbb. In this case, the buffer memory comprises one message (Ma) and the number of pings to be performed in 10 s is 7. Therefore, the message Mb is placed in the buffer memory.

The buffering time at T0+2 s for the message Ma is Tba (T0+2 s)=8−2=6 s, which is less than the maximum time Tbb of 10 s. Then, the message Mb is placed in the second position in the buffer memory behind the message Ma.

At T0+3 s, the message Ma is sent over channel C1 instead of a ping P1. It should be noted that Tbb (T0+3 s)=9 s. One second has elapsed since the buffering of the message Mb.

At T0+3.5 s, the message Mc is received by the on-board system 4.

In the next 5 s, 2 pings are to be sent, while the buffer memory contains a single message (Mb). Therefore, the message Mc is placed in the buffer memory.

The buffering time at T0+3.5 s for the message Mb is Tbb (T0+3.5 s)=10−3.5+2=10−1.5 s=8.5 s, which is greater than the maximum time Tbc of 5 s. So, the message Mb is placed in the second position in the buffer memory, while the message Mc is placed in the first position.

The next ping arrives at T0+4 s. The first message in the buffer is sent as a ping. This is the message Mc, which is therefore delayed by 0.5 s before being sent for Tp2. The message Mb, which was initially scheduled to be sent at T0+4 s (that is, a 2 second delay), spends 3 seconds in the buffer memory. It will therefore be delayed by 3 seconds.

It should be noted that when a non-eligible useful message is sent over the utilization channel, or the best channel, the chronology of the channel “ping” periods is reset (step 107) to the time the message was sent.

For example, when the priority channel is C3 and a non-eligible message arrives at T0, the sent non-eligible message acts as a ping without being placed in the buffer memory. As it is non-eligible, it is sent directly. Its sending is still used as a measurement.

At this point (T0 in the example), the chronology of the pings is reviewed. The link C3 benefits from a measurement at T0. With its ping period being Tp3=8 sec, its next ping will occur at T0+8 sec, then T0+16 sec, then T0+24 sec, etc. The pings of the other channels remain unchanged. Therefore, the list of the next pings changes slightly since the Tp3s slide toward the bottom of the list). It should be noted that the system then checks that there are not too many messages in the buffer memory. If there are too many, the first messages in the buffer are immediately sent.

It should be noted that, irrespective of the embodiment, the number of ping messages required for the communication system 1 to function properly is reduced, which frees up bandwidth and reduces the energy to be supplied, as well as the associated cost.

FIG. 7 schematically illustrates an example of the internal architecture of the on-board system 4 of the aircraft 2. As can be seen from this figure, the on-board system 4 then comprises, connected by a communication bus 1000: a processor or CPU (Central Processing Unit) 1001; a RAM (Random Access Memory) 1002; a ROM (Read Only Memory) 1003; a storage unit, such as a hard disk (or a storage medium reader, such as an SD (Secure Digital) card reader 1004; communication interfaces 1005, 1006 and 1007 configured to establish communications over communication channels C1, C2 and C3, respectively. The on-board communication system 4 further comprises input/output port type interfaces, notably of the type for receiving and transmitting signals to and from third-party devices of the aircraft.

The processor 1001 is able to execute instructions loaded into the RAM 1002 from the ROM 1003, from an external memory (not shown), from a storage medium (such as an SD card), or attached to a communication network. When the on-board system 4 is powered up, the processor 1001 is able to read instructions from the RAM 1002 and to execute them. These instructions form a computer program causing the processor 1001 to implement the method 100.

The random access memory comprises at least one buffer memory: a respective memory for each channel C1, C2, C3, according to the first embodiment, and a memory common to the three channels C1, C2 and C3 according to the second embodiment.

All or some of the method implemented by the on-board system 4, or its described variants, can be implemented in software form by executing a set of instructions using a programmable machine, for example, a DSP (“Digital Signal Processor”) or a microcontroller, or can be implemented in hardware form by a machine or a dedicated component, for example, an FPGA (Field-Programmable Gate Array) or an ASIC (Application-Specific Integrated Circuit). In general, the on-board system 4 comprises electronic circuitry configured to implement the methods and sub-methods described in relation thereto, allowing communications to be established between the aircraft 2 and the remote station 3. Of course, the on-board communication system 4 further comprises all the elements usually present in a system comprising a control unit and its peripherals, such as, notably, a power supply circuit, a power supply monitoring circuit, one or more clock circuits, a reset circuit, input/output ports, interruption inputs, bus drivers, digital-to-analogue and analogue-to-digital converters, ideally fast converters, with this list being non-exhaustive.

Although the implementations described above have been described and represented with reference to particular steps executed in a particular order, it will be understood that these steps can be combined, subdivided or reordered without deviating from the teaching of the present disclosure. At least some of the steps can be executed in parallel or in series. Consequently, the order and the grouping of the steps does not constitute a limitation of the disclosure herein.

Modifications and improvements to the implementations of the disclosure herein described above may become apparent to a person skilled in the art. The above description is illustrative through examples rather than limiting. Therefore, the scope of the disclosure herein is only limited by the scope of the following claims.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for selecting a communication channel, called utilization channel, from among a plurality of communication channels between an on-board communication system of an aircraft and a communication station, called remote station, disposed at a distance from the aircraft, the method comprising:
determining, for each of the communication channels, one or more items of information representing a transmission quality of a message between the on-board system and the remote station, the message being either a useful message received by the on-board system, with the useful message being a message transmitted to the on-board system by a source transmitting application on board the aircraft, or a probe message, called ping message, with the ping messages being transmitted over a given period;
classifying the communication channels according to indices respectively representing transmission qualities determined for each of the channels, based on the determined information, with a single index being assigned for each channel;
selecting the utilization channel as being the channel, from among the communication channels, exhibiting a best transmission quality based on the indices;
the method also comprising:
determining a buffering time, called eligibility time, for each received useful message; and, if the eligibility time is non-zero,
transmitting the useful message, called eligible useful message, instead of a ping message via the utilization channel.

2. The selection method of claim 1, comprising analyzing buffering of the eligible useful message, comprising a checking step depending on a state of the buffer memory and a parameter relating to the eligible useful message.

3. The selection method of claim 2, wherein the on-board system comprises at least one buffer memory, wherein analyzing the buffering of the eligible useful message comprises determining an order for filling the at least one buffer memory.

4. The selection method of claim 3, wherein the on-board system comprises a buffer memory dedicated to each channel, wherein, during the checking step, for the channel whose buffer memory is to be filled as a priority according to the order obtained on completion of determining a filling order, if the buffer memory is empty, and if a maximum message buffering time is greater than a duration remaining until a next transmission of a ping message, then the eligible useful message is placed in the buffer memory during analyzing buffering.

5. The selection method of claim 4, wherein, if the maximum message buffering time is less than or equal to the duration remaining until the next transmission of a ping message, then the eligible useful message is not placed in the buffer memory and is sent as a useful message during a sending step.

6. The selection method of claim 2, wherein the on-board system comprises a buffer memory common to all the channels, wherein, during comparing between a state of the buffer memory and a parameter of the eligible useful message, a number of messages, called number of messages, contained in the buffer memory is compared with a total number of ping messages, called number of pings, to be sent over a time equal to a maximum message buffering time and, if the number of pings is greater than the number of messages, then the eligible useful message is placed in the buffer memory, during analyzing buffering.

7. The selection method of claim 6, wherein, if the number of pings is less than or equal to the number of messages, then the eligible useful message is not placed in the buffer memory and is sent as a useful message during a sending step.

8. An on-board communication system to equip an aircraft, configured to establish communications with a remote communication station through a communication channel, called best channel, from among a plurality of communication channels, with the on-board system being configured to implement steps of:
a step of determining, for each of the communication channels, one or more items of information representing a transmission quality of a message between the aircraft and the remote station, the message being either a useful message received by the on-board system, with this useful message being a message transmitted to the on-board system by a source transmitting application on board the aircraft, or a probe message, called ping message, with the ping messages being transmitted over a given period;
a step of classifying the communication channels according to indices respectively representing end-to-end transmission qualities determined for each of the channels, based on the determined information, with a single index being assigned for each channel;
a step of selecting the utilization channel as being the channel, from among the communication channels, exhibiting a best transmission quality based on the indices;
a step of determining a buffering time, called eligibility time, for each received useful message; and, if the eligibility time is non-zero,
a step of transmitting the useful message, called eligible useful message, instead of a ping message.

9. An aircraft comprising the on-board communication system of claim 8.

10. A computer-readable medium comprising instructions for executing the method of claim 1.
